(19) United States
(12) Patent Application Publication
(10) Pub. No.: US 2011/0150038 A1
(43) Pub. Date: Jun. 23, 2011

(54) SYSTEM AND METHOD FOR UWB TRANSMISSION PREDISTORTION AND RF WIRE-BOND INTERFACE TECHNIQUE RELATED APPLICATION

(76) Inventors: Victor KOROL, San Diego, CA (US); Zohar Kaufman, Rishon LeZion (IL); Sorin Goldenberg, Ness Tziona (IL); Gadi Shor, Tel Aviv (IL)

(21) Appl. No.: 12/911,757

(22) Filed: Oct. 26, 2010

Related U.S. Application Data
(60) Provisional application No. 61/255,130, filed on Oct. 27, 2009.

(51) Int. Cl. H04B 15/00; H04B 1/00

(52) U.S. Cl. 375/130; 375/285; 375/E01.002

(57) ABSTRACT

A method and a system, the system includes: an analog base-band pre-distorter arranged to receive in-phase (I) baseband signals and Quadrature (Q) baseband signals, and to amplify the I baseband signals and the Q baseband signals by a gain function to provide amplified I baseband signals and amplified Q baseband signals; wherein the gain function is responsive to a sum of (a) a square of amplitudes of the I baseband signals and, (b) a square of amplitudes of the B baseband signals; a frequency converter arranged to convert the amplified I and Q baseband signals to radio frequency (RF) signals; an RF amplifier that is arranged to amplify the RF signals to provide amplified RF signals and to output differential RF signals that represent the amplified RF signals through first and second differential output ports of the RF amplifier; a balun comprising a first and second balanced input ports and a single unbalanced output port; and multiple wire-bonds coupled between the balun and the first and second differential output ports of the RF amplifier; wherein at least one wire-bond serve as potential shunt inductor.

### RELATED APPLICATION

This application claims priority from U.S. provisional patent application Ser. No. 61/255,130 filing date Oct. 27, 2009.

### BACKGROUND OF THE INVENTION

Various ultra wideband standards became increasingly popular platform for implementing short range high data rate communication in various types of consumer electronic products.

The need to maintain low power consumption while providing a reliable link justifies the development of a Radio Frequency Transmitter Pre-distortion Linearization System.

### SUMMARY

According to an embodiment of the invention a system is provided. The system may include an analog base-band pre-distorter arranged to receive in-phase (I) baseband signals and Quadrature (Q) baseband signals, and to amplify the I baseband signals and the Q baseband signals by a gain function to provide amplified I baseband signals and amplified Q baseband signals; wherein the gain function is responsive to a sum of (a) a square of amplitudes of the I baseband signals and, (b) a square of amplitudes of the B baseband signals; a frequency converter arranged to convert the amplified I and Q baseband signals to radio frequency (RF) signals; an RF amplifier that is arranged to amplify the RF signals to provide amplified RF signals and to output differential RF signals that represent the amplified RF signals through first and second differential output ports of the RF amplifier; a balun comprising a first and second balanced input ports and a single unbalanced output port; multiple wire-bonds coupled between the balun and the first and second differential output ports of the RF amplifier; wherein at least one wire-bond serve as potential shunt inductor.

The system may include a first interface port that is coupled to a third interface port and is coupled via a wire-bond to the first balanced input port of the balun; a second interface port that is coupled to the first differential output port of the RF amplifier; a third interface port that is coupled via a wire-bond to direct current (DC) source; a fourth interface port that is coupled to the second differential output port of the RF amplifier; and a fifth interface port that is coupled to the third interface port and is coupled via a wire-bond to the second balanced input port of the balun.

The system may include a receiver that comprises a first and second differential inputs; wherein the second interface port may be further coupled to the first differential input of the receiver; and wherein the fourth interface port is further coupled to the second differential input of the receiver.

The wire-bonds may couple between a balun that is connected to a substrate and between an integrated circuit that comprises the analog base-band pre-distorter, the frequency converter and the RF amplifier.

The frequency converter may be arranged to convert the amplified I and Q baseband signals to ultra wide band (UWB) RF signals.

The analog base-band pre-distorter may include: an I-channel envelope detector, a Q-channel envelope detector, an I-channel pre-distortion amplifier that is coupled to the I-channel envelope detector and to the Q-channel envelope detector; and a Q-channel pre-distortion amplifier that is coupled to the I-channel envelope detector and to the Q-channel envelope detector.

The I-channel pre-distortion amplifier may include two feedback resistors; wherein a resistance of a first feedback resistor is modulated by the I-channel envelope detector and a resistance of a second feedback resistor is modulated by the Q-channel envelope detector.

The system may include an I-channel offset circuit arranged to set a small signal gain of the I-channel pre-distortion amplifier and a Q-channel offset circuit arranged to set a small signal gain of the Q-channel pre-distortion amplifier.

The system according to claim 6, further comprising a reference gain feedback loop that is coupled to the I-channel pre-distortion amplifier and to the Q-channel pre-distortion amplifier.

The reference gain feedback loop may include at least one reference pre-distortion amplifier that comprises poly-silicon feedback resistors.

According to an embodiment of the invention a method for transmitting signals is provided. The method may include receiving, by a an analog base-band pre-distorter, in-phase (I) baseband signals and Quadrature (Q) baseband signals; amplifying the I baseband signals and the Q baseband signals by a gain function to provide amplified I baseband signals and amplified Q baseband signals; wherein the gain function is responsive to a sum of (a) a square of amplitudes of the I baseband signals and, (b) a square of amplitudes of the B baseband signals; converting, by a frequency converter, the amplified I and Q baseband signals to radio frequency (RF) signals; amplifying, by an RF amplifier, the RF signals to provide amplified RF signals; outputting differential RF signals from a first and a second differential output ports of the RF amplifier, wherein the differential RF signals represent the amplified RF signals; supplying the differential RF signals to an interface that is coupled via multiple wire-bonds coupled to two balanced input ports of a balun; wherein at least one wire-bond serve as potential shunt inductor; and outputting RF signals from a single unbalanced output port of the balun to an antenna.

The multiple wire-bonds may be coupled to a first till fifth interfacing ports, wherein the method may include providing RF differential signals from a first differential output port of the RF amplifier to a second interfacing port; providing RF differential signals from a second differential output port of the RF amplifier to a fourth interfacing port; wherein the first interface port is coupled to a third interface port and is coupled via a wire-bond to the first balanced input port of the balun; wherein the third interface port is coupled via a wire-bond to direct current (DC) source; and wherein the fifth interface port that is coupled to the third interface port and is coupled via a wire-bond to the second balanced input port of the balun.

The method may include providing RF signals from the balun to a receiver that comprises a first and second differential inputs; wherein the second interface port is further coupled to the first differential input of the receiver; and wherein the fourth interface port is further coupled to the second differential input of the receiver.

The wire-bonds may couple between a balun that is connected to a substrate and between an integrated circuit that comprises the analog base-band pre-distorter, the frequency converter and the RF amplifier.

The method may include converting the amplified I and Q baseband signals to ultra wide band (UWB) RF signals.

The method may include: detecting an envelop of the I-channel baseband signals by an I-channel envelope detector; detecting an envelop of the Q-channel baseband signals by a Q-channel envelope detector, amplifying, in response to the detected envelope of the I-channel baseband signals and the detected envelope of the Q-channel baseband signals, the I baseband signals by an Q-channel pre-distortion amplifier; and amplifying, in response to the detected envelope of the I-channel baseband signals and the detected envelope of the Q-channel baseband signals, the Q baseband signals by a Q-channel pre-distortion amplifier.

The I-channel pre-distortion amplifier may include two feedback resistors; wherein the method may include modulating a resistance of a first feedback resistor by the I-channel envelope detector and modulating a resistance of a second feedback resistor by the Q-channel envelope detector.

The method may include setting a small signal gain of the I-channel pre-distortion amplifier by an I-channel offset circuit; and setting a small signal gain of the Q-channel pre-distortion amplifier by a Q-channel offset circuit.

The method may include setting a small signal gain of the I-channel pre-distortion amplifier and of the Q-channel pre-distortion amplifier by a reference gain feedback loop that is coupled to the I-channel pre-distortion amplifier and to the Q-channel pre-distortion amplifier.

The reference gain feedback loop may include at least one reference pre-distortion amplifier that comprises poly-silicon feedback resistors.

### BRIEF DESCRIPTION OF THE PRESENT INVENTION

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

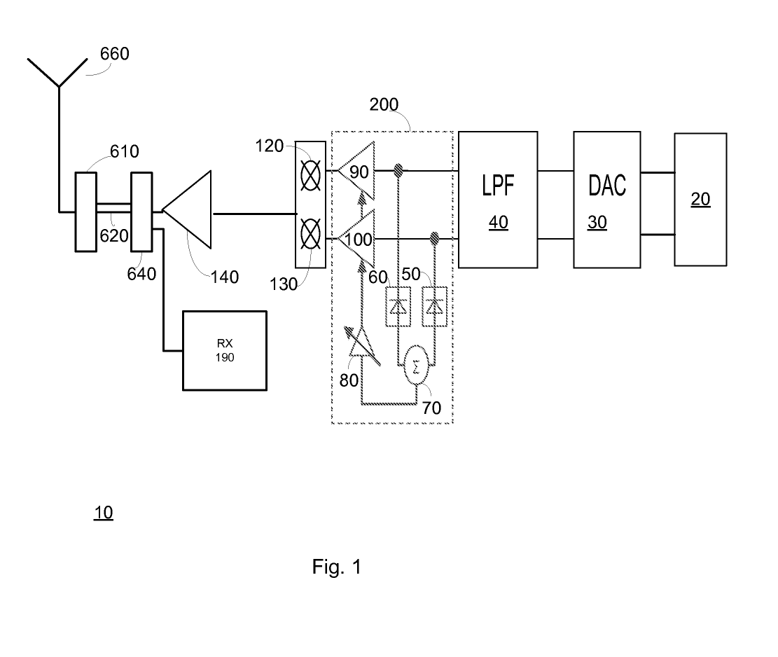

FIG. 1 illustrates a system, according to an embodiment of the invention;

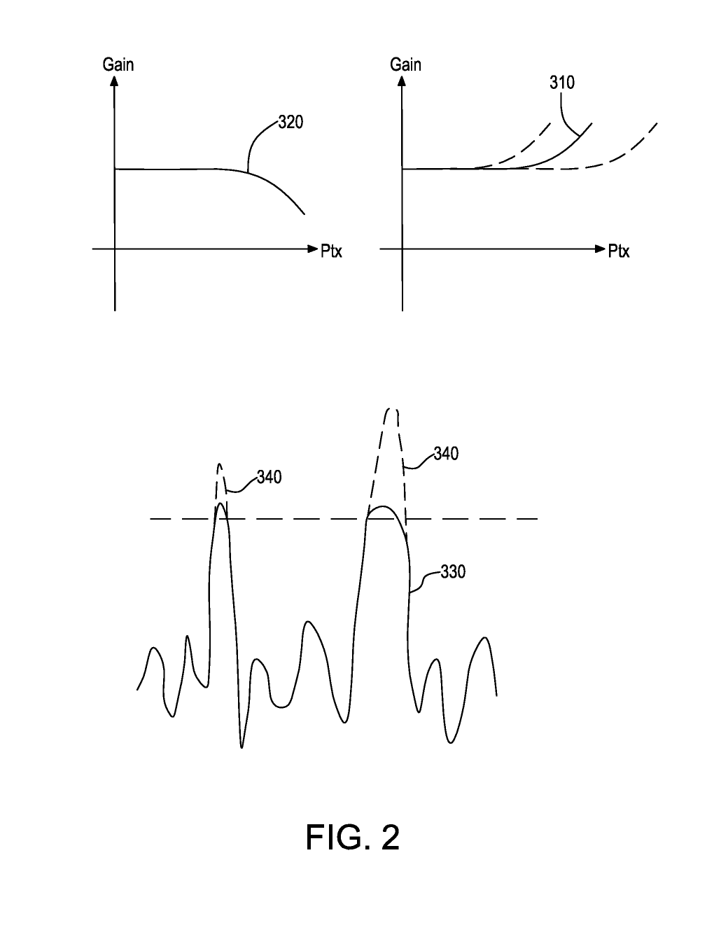

FIG. 2 illustrates a gain function and a signal affected by the gain function of a pre-distortion amplifier according to an embodiment of the invention;

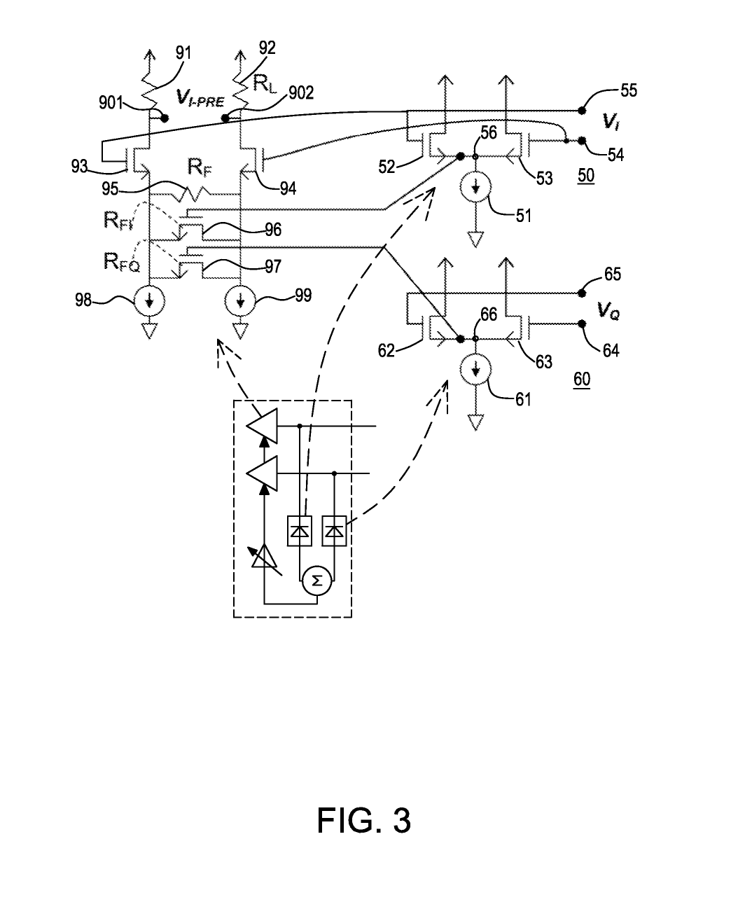

FIG. 3 illustrates an analog base-band pre-distorter, according to an embodiment of the invention;

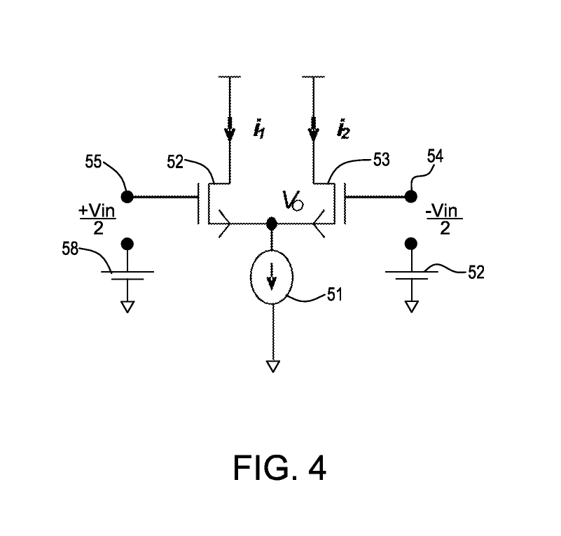

FIG. 4 illustrates an I-channel envelope detector, according to an embodiment of the invention;

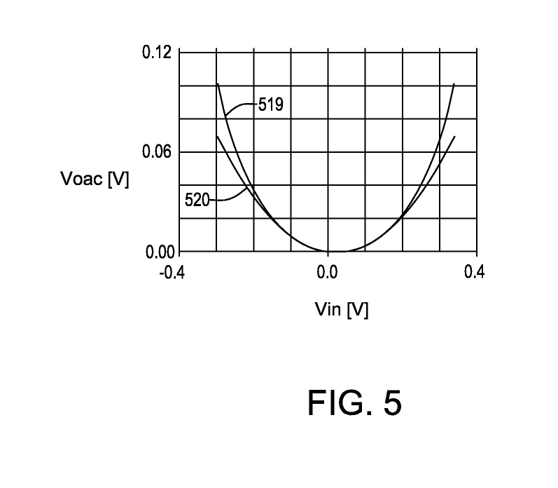

FIG. 5 illustrates two approximations of the relationship between the input voltage to the I-channel envelope detector and the output voltage of the Q-channel envelope detector 50, according to an embodiment of the invention;

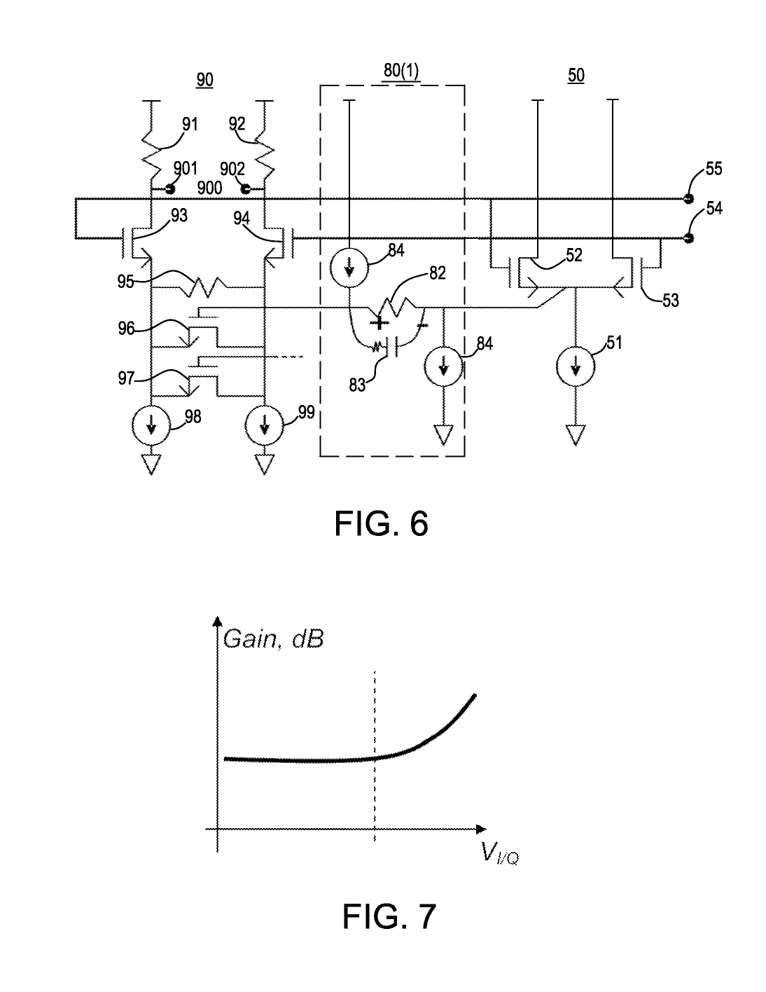

FIG. 6 illustrates an I-channel offset circuit, an I-channel pre-distortion amplifier and an I-channel envelope detector, according to an embodiment of the invention;

FIG. 7 illustrates a gain function according to an embodiment of the invention;

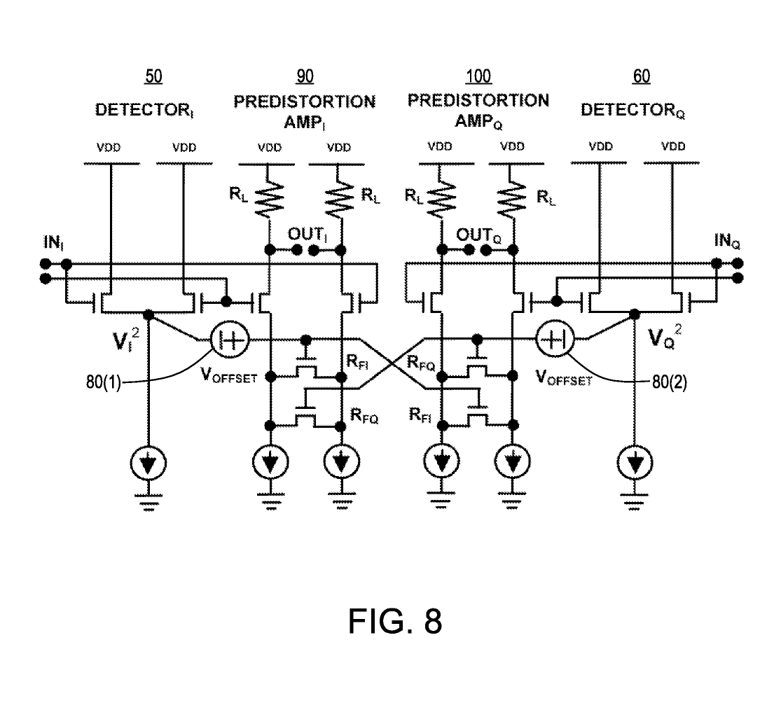

FIG. 8 illustrates an analog base-band pre-distorter according to an embodiment of the invention;

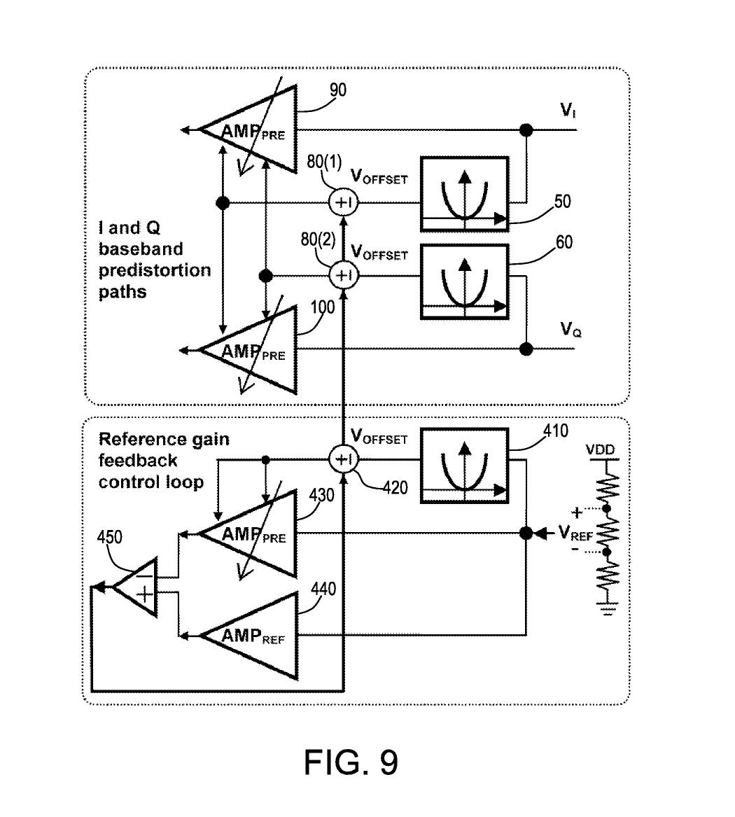

FIG. 9 illustrates an analog base-band pre-distorter and a feedback circuit according to an embodiment of the invention;

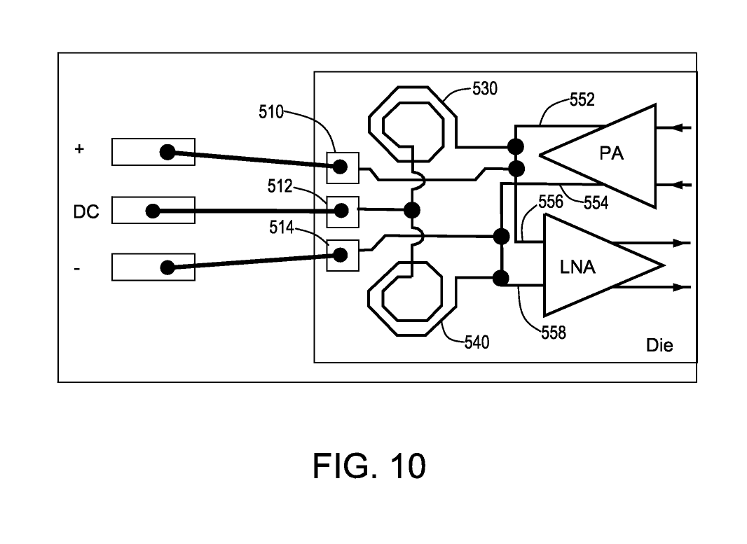

FIG. 10 illustrates a prior art differential RF Interface;

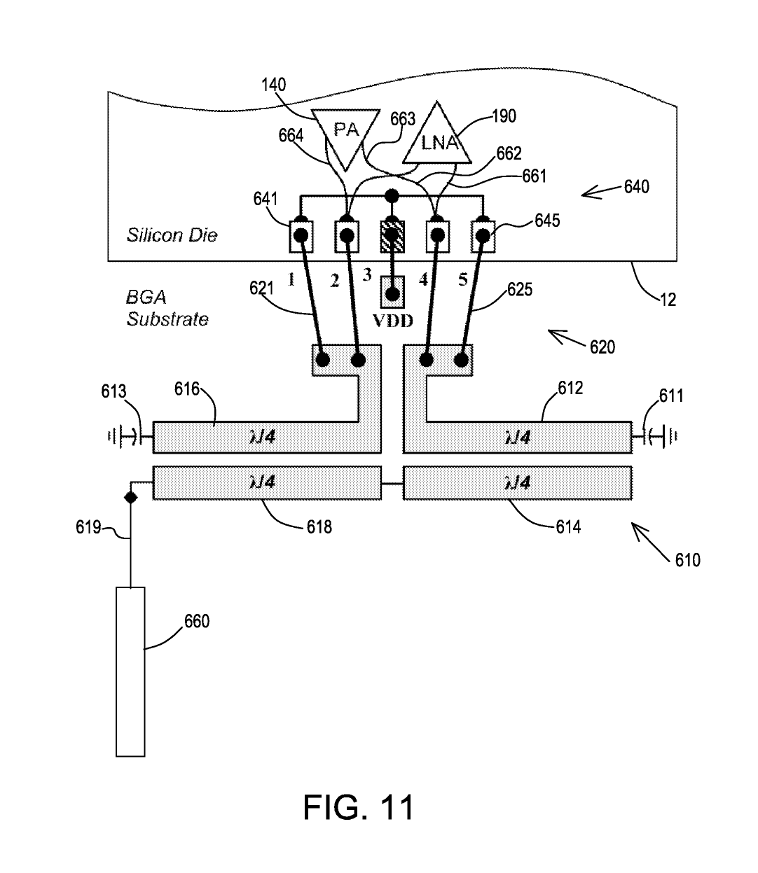

FIG. 11 illustrates a differential RF Wire-bond Interface, a balun and an antenna substrate, according to an embodiment of the invention;

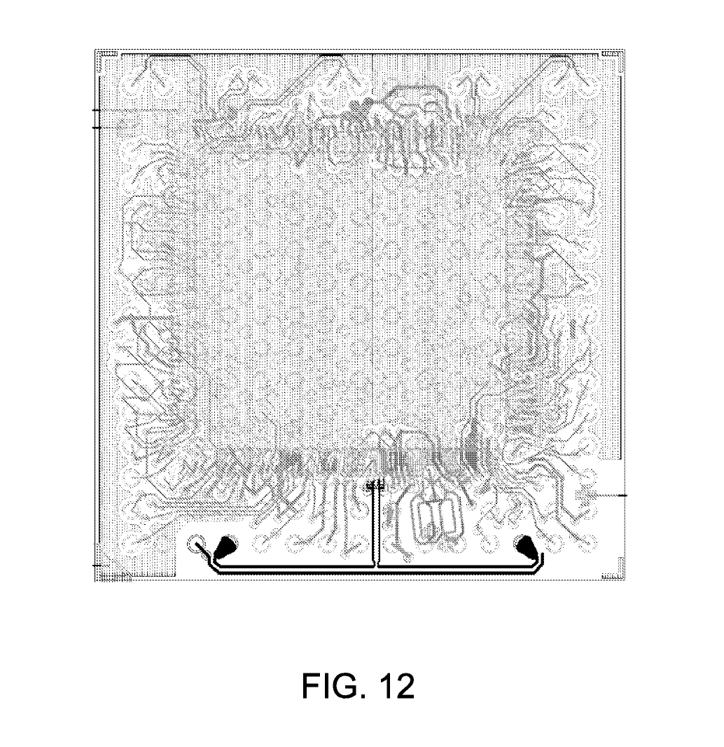

FIG. 12 illustrates a layout of an integrated circuit and its surrounding according to an embodiment of the invention; and

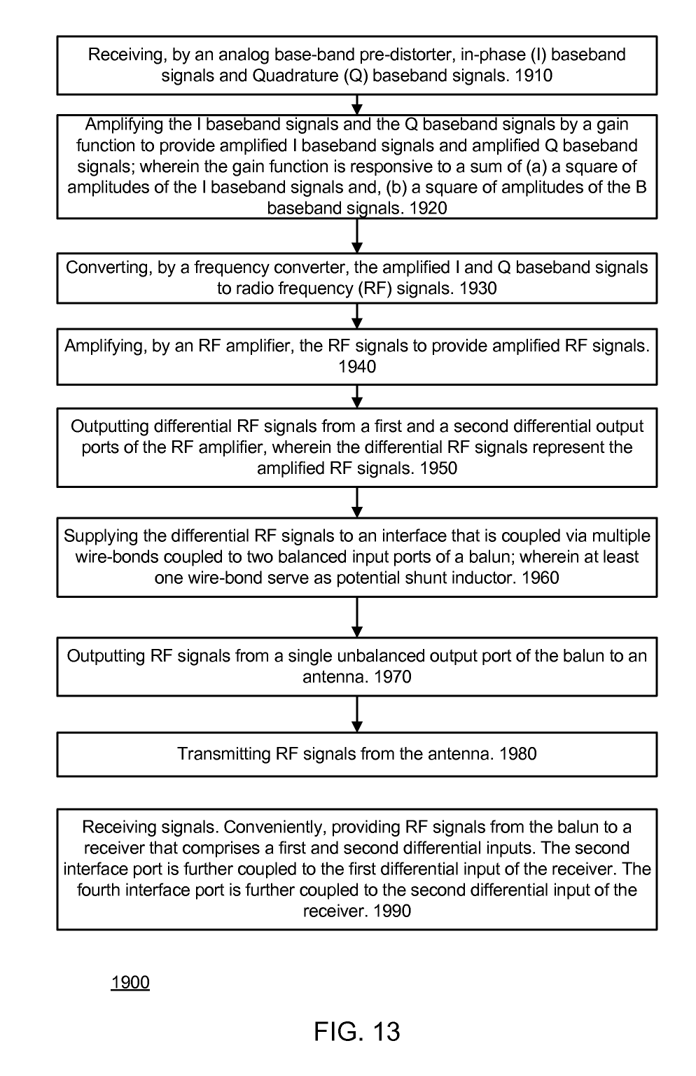

FIG. 13 illustrates a method according to an embodiment of the invention.

### DETAILED DESCRIPTION OF THE PRESENT INVENTION

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Transmission pre-distortion system allows an increase in the maximum usable linear power of the transmitter.

The quadrature analog base-band pre-distortion approach is proposed as cost and power efficient method for increasing of the transmission power suitable for the ultra-wideband RF transmitter.

Additional transmission power and transmitter efficiency increase can be obtained by minimization of loss at interface between the transmission chip and antenna. The proposed wire-bond RF interfacing technique reduces RF power loss and provides compact and cost efficient solution for wide band RF interconnection interface.

FIG. 1 illustrates a system 10, according to an embodiment of the invention.

System 10 includes a source signal 20 for providing in-phase (I) digital signals and Quadrature (Q) digital signals to a digital to analog converter (DAC) 30. The DAC 30 outputs in-phase (I) analog signals and Quadrature (Q) analog signals to a low power filter (LPF) 40. The LPF 40 outputs in-phase (I) baseband signals and Quadrature (Q) baseband signals to the analog base-band pre-distorter 200.

The analog base-band pre-distorter 200 is arranged to receive in-phase (I) baseband signals and Quadrature (Q) baseband signals, and to amplify the I baseband signals and the Q baseband signals by a gain function to provide amplified I baseband signals and amplified Q baseband signals. The gain function is responsive to a sum of (a) a square of amplitudes of the I baseband signals and, (b) a square of amplitudes of the B baseband signals. FIG. 1 illustrates the analog base-band pre-distorter 200 as including I-channel and Q-channel pre-distortion amplifiers 90 and 100, I-channel and Q-channel envelope detectors 50 and 60, a summing unit 70 and an offset circuit 80. It is noted, and as illustrated by FIGS. 3,6 and 8 that the analog base-band pre-distorter 200 may include an I-channel offset circuit 80(1), a Q-channel offset circuit 80(1) instead of a single offset circuit 80 and that the summation can be implemented by allowing modulation of resistance of parallel feedback resistors by both Q-channel and Q-channel envelope detectors 50 and 60.

Amplified I and Q signals are outputted from the analog base-band pre-distorter 200 to a frequency converter (illustrated as including a I mixer 120 and a Q mixer 130) and is arranged to convert the amplified I and Q baseband signals to radio frequency (RF) signals. The RF signals are provides to an RF amplifier 140.

The RF amplifier 140 is arranged to amplify the RF signals to provide amplified RF signals and to output differential RF signals that represent the amplified RF signals through first and second differential output ports of the RF amplifier. These differential RF signals are provided to an interface 640 that is coupled via multiple wire bonds 620 to a balun 610. At least one wire-bond (of multiple wire-bonds 620) serves as potential shunt inductor.

The balun 610 includes a first and second balanced input ports and a single unbalanced output port.

FIG. 1 also illustrates an antenna 660 as being connected to the balun 610 and to a receiver 190.

The system may be designed to be low cost and low power. An analog base-band pre-distorter (also referred to as pre-distortion block) 200 is located at analog base-band In-phase and Quadrature signal channels. As opposed to the digital baseband predistortion implementation, the proposed system does not require several fold increase of the In-phase (I) and Quadrature (Q) Digital to Analog Conversion (DAC) conversion rate. Placing the analog base-band pre-distorter 200 at base-band frequency also prevents Amplitude Modulation—Phase Modulation (AM-PM) distortion and RF bandwidth degradation associated with implementing the gain expansion function at RF frequency.

In this disclosed system 10, I-channel and Q-channel envelope detectors 50 and 60 produce approximately square law VÎ2 and VQ̂2 signals.

The sum of two the signals (VÎ2+VQ̂2) controls the gain expansion function of the I-channel and Q-channel pre-distortion amplifiers (I-channel and Q-channel baseband pre-distortion amplifiers). The gain expansion increases the amplitude of the signal at the higher levels of the RF signal counteracting the compression at the RF power amplifier 140—as illustrated in FIG. 2.

According to an embodiment of the invention the pre-distortion amplifiers 90 and 100 also receive a gain affecting signal from a digital pre-distortion block (not shown). This digital pre-distortion block can assist in setting pre-distortion function parameters such as small signal gain (baseline gain), gain expansion threshold and steepness of the gain expansion. Digital pre-distortion block may be fed (or calculate) average transmitted power (may sample the transmitted power from the output of the RF amplifier 140), peak transmitted power or other parameters in order to obtain a set of pre-distortion control values and program those values to the appropriate blocks in the digital pre-distortion apparatus.

The pre-distortion parameters and their relation to the transmitted power (average or/and peak) may be are chosen to minimize the overall distortion of the transmitted signal. The pre-distortion control function may be implemented as look up table or closed analytical expression.

FIG. 2 illustrates a gain function 320 of the RF amplifier 140. The gain function decreases over a certain frequency. FIG. 2 also illustrates a gain function 310 of either one of the I-channel and Q-channel pre-distortion amplifiers 90 and 100. The gain function 310 that increases over the certain frequency. FIG. 2 further illustrates a signal 330 that is amplified by the I-channel and Q-channel pre-distortion amplifiers as illustrated by arrows 340. An amplified signal has an envelope that ends by curved lines that connect the edge of these arrows 340 to curve 330.

Referring back to FIG. 1, the placement of the I-channel and Q-channel envelope detectors (In-phase and Quadrature square law voltage detectors) 50 and 60 in analog baseband section of the system 10 allows low complexity and low cost implementation.

The system 10 does not require oversampling rate at I-channel and Q Digital to Analog Converters as in case of digital baseband pre-distortion implementation. The system 10 is also insensitive to the particular and changing RF frequency of operation since the detection is done at the base-band frequency.

Placement of the I-channel and Q-channel pre-distortion amplifiers 90 and 100 at analog baseband offers benefit of uncompromised RF bandwidth and reduction of AM-PM distortion that would occur if the gain expansion (predistortion) was implemented at RF frequency.

FIG. 3 illustrates an I-channel envelope detector 50, a Q-channel envelope detector 60 and an I-channel pre-distortion amplifier 90, according to an embodiment of the invention. FIG. 4 illustrates an I-channel envelope detector 50 according to an embodiment of the invention.

The I-channel pre-distortion amplifier 90 may be identical to the Q-channel pre-distortion amplifier 100. The I-channel pre-distortion amplifier 90 is a differential amplifier that has two branches. Feedback resistors Rf 95, Rfi 96 and Rfq 97 are connected between these two branches. FIG. 3 illustrates these feedback resistors 95-97 as being connected between two drains of transistors 93 and 94. These drains are also connected to current drains 98 and 99.

The difference between the signals provided to the gates of transistors 93 and 94 can be referred to as an I-channel baseband signal. Each of the sources of transistors 93 and 94 is connected to a different output port, wherein the output ports output an amplified I-channel signal.

Each of the sources of transistors 93 and 94 is also connected to a power source via a load resistor such as load resistors 91 and 92.

The I-channel envelope detector 50 includes two transistors 52 and 53 that their drains are connected to each other and to a current drain 51 at an output node. The output node is connected to the gate Rfi 96. The gates of transistors 52 and 53 receive input signals, wherein the difference between the input signals provided to the gates is the I-channel baseband signal whose envelope is being detected. The gate of transistor 53 can receive (via input port 54) a voltage that has a value of −VQ/2, while the gate of transistor 53 can receive via port 54 a voltage that has a value of VQ/2.

Each of the sources of transistors 52 and 53 is connected to a power source.

The Q-channel envelope detector 60 includes two transistors 62 and 63 that their drains are connected to each other and to a current drain 61 at an output node. The output node is connected to the gate Rfq 97. The gates of transistors 62 and 63 receive input signals, wherein the difference between the input signals provides to the gates is the Q-channel baseband signal whose envelope is being detected. Each of the sources of transistors 62 and 63 is connected to a power source.

The I-channel envelope detector 50 (and the Q-channel envelope detector 60), having approximately square law detection characteristics, control the gain of the I-channel pre-distortion amplifier 90 (and of the Q-channel pre-distortion amplifier 100 of FIG. 1) by modulating the resistance of the feedback resistors Rfi 96 and Rfq 97 of the I-channel pre-distortion amplifier 90 (and of the Q-channel envelope detector 60).

Rfi 96 and Rfq 97 may be CMOS triode controlled feedback resistors that receive at their gates signals from the I-channel envelope detector 50 and the Q-channel envelope detector 60. These signals modulate their resistance.

The mentioned above connectivity implements a (VÎ2+VQ̂2) gain function.

The gain of the I-channel and Q-channel pre-distortion amplifiers 90 and 100 can be approximated by the closed loop feedback amplifier gain:

G≅R_{L}·(¹/_{R}_{_{F}}⇄[¹/_{R}_{_{FI}}+¹/_{R}_{_{FQ}}]) (1)

Referring to Rfi 97 and Rfq 97—they may be operated in the linear region and have their resistance proportional to the Gate-Source voltage which in turn is proportional to the square I and Q baseband signals. Accordingly:

¹/_{R}_{_{FI}}∝V_{I}²,¹/_{R}_{_{FQ}}∝V_{Q}² (2)

The gain function of each of the I-channel and Q-channel pre-distortion amplifiers 90 and 100 may be proportional to the sum of the I-channel and Q squared voltages:

G∝V_{I}²+V_{Q}² (3)

According to an embodiment of the invention, the I-channel and Q-channel envelope detectors 50 and 60 can operate as differential pair detectors and can be used for detecting the I-channel and Q squared voltages. Such a detector topology resembles the differential topology of the I-channel pre-distortion amplifier 90 and the Q-channel pre-distortion amplifier 100. This may simplify the direct current (DC) match of these components. It is noted that the DC difference between these components can control the small-signal value of the triode CMOS feedback resistors.

Referring to FIG. 4, the source drain current drained by transistor 53 from a supply source is denoted i2 and the source drain current drained by transistor 52 from a supply source is denoted i1. VI is be denoted Vin.

As will be shown, the detector voltage detection function approximates the required square law function within the region of interest

Writing the Kirchhoff equations as well as small-signal transconductance of the transistors 52 and 53 results in the following set of equations:

$${i}_{1} = {{I}_{0} ( {V}_{G} + {V}_{0} - {V}_{t} + \frac{{V}_{IN}}{2} )}^{2} \\ {i}_{2} = {{I}_{0} ( {V}_{G} + {V}_{0} - {V}_{t} - \frac{{V}_{IN}}{2} )}^{2} \\ {i}_{2} + {i}_{2} = 2 {I}_{DC} \\ {V}_{0} = {V}_{0 - DC} + {V}_{0 - AC} \\ {g}_{m} = \frac{2 {I}_{D C}}{{V}_{G} - {V}_{0 - DC} - {V}_{t}} \qquad ( 4 )$$

Solving (4) for the AC component of the detector output voltage V0-AC yields:

$${V}_{0} = {V}_{0 - DC} - \frac{2 {I}_{DC}}{{g}_{m}} \sqrt{1 - \frac{{g}_{m}^{2}}{16 {I}_{DC}^{2}} {V}_{IN}^{2}} \qquad ( 5 )$$

Equation (6) does not show obvious resemblance with the asserted square law behavior. To show that it indeed approaches parabolic behavior it will be decomposed into the Taylor series expansion.

$${V}_{0} = {V}_{0 - DC} + \frac{1}{16} \frac{{g}_{m}}{{I}_{DC}} {V}_{IN}^{2} + \frac{1}{341.3} \frac{{g}_{m}^{3}}{{I}_{DC}^{3}} {V}_{IN}^{4} + … \qquad ( 6 )$$

Plotting the detection function with the actual values of gm=8 micro-Seconds and IDC=650 micro-Ampere shows that for voltages within 250 mV range (input signal range) the detector is well approximated by the square law function.

FIG. 5 illustrates two approximations of the relationship between the input voltage to the I-channel envelope detector and the output voltage of the I-channel envelope detector 50, according to an embodiment of the invention.

Curve 510 illustrates a first approximation that is a fourth order polynomial fit y=5.0795x̂4+0.629x̂2+0.0007, y being the output voltage and x being the input voltage. The expression alp equals a by a power of b. Curve 520 illustrates a second approximation that is a second order truncated Taylor series expansion y=0.769x̂2.

Curve 520 shows that truncating the Taylor series beyond the quadratic term does not introduce a significant error within the input operating range of ±250 mVp.

The small signal gain of each of the I-channel and Q-channel pre-distortion amplifiers 90 and 100 is set by the direct current (DC) resistance of feedback resistors Rf1 96 and Rfq 97. Without an offset voltage to these resistors these feedback transistors Rfi 96 and Rfq 97 would be in a cut-off region (Vgs=0).

Accordingly, an offset voltage should be set between the output of I-channel envelope detector 50 and the gate of Rfi 96. An offset should be set should set between the output of the Q-channel envelope detector 60 and the gate of Rfq 97.

The offset voltage can be obtain in various manners. For example, the offset can be obtained by passing a DC current through an offset resistor Roffset (denoted 82 in FIG. 6). The size of the offset resistor Roffset and consequently the DC offset current can be responsive to a bandwidth requirement (Bandwidth≈1 GHz). The bandwidth is set by the resistance of the offset resistor Roffset and the gate capacitance of the CMOS triode resistor (Rfi 96 and Rfq 97).

FIG. 6 illustrates an I-channel offset circuit 80(1) connected between the I-channel pre-distortion amplifier 90 and the I-channel envelope detector 50.

FIG. 8 illustrates the an I-channel offset circuit 80(1) as well as a similar offset circuit (Q-channel offset circuit 80(2)) that is connected between the Q-channel pre-distortion amplifier 100 and the Q-channel envelope detector 60, according to an embodiment of the invention.

The I-channel offset circuit 80(1) includes an offset resistor (Roffset) 82 having a first end that is connected to the output node of the I-channel offset circuit 80(1). Roffset 82 has a second end that is connected to the gate of Rfi 96, to an offset current source Ioffset 81 and to an offset capacitor Coffset 83. The first end of Roffset 82 is also connected to a current drain 84 and to a first end of Coffset 83. The voltage developed over Coffset is denoted Voffset.

In order to increase the bandwidth without increasing the offset current (reducing the offset resistor) Coffset 83 is coupled in parallel to Roffset 82. The zero in the signal path is set at a bandwidth of approximately 1 GHz, partially compensating the gain/phase roll off around the 3 dB-BW frequency.

FIG. 7 illustrates a gain function according to an embodiment of the invention.

Curve 400 represents the gain function of a pre-distortion amplifier (such as 90 or 100) versus (VÎ2+VQ̂2). The gain is constant for (VÎ2+VQ̂2) values that are below a threshold level G=RL/RF. Above the threshold level the Gain is proportional to (VÎ2+VQ̂2).

FIG. 9 illustrates an analog base-band pre-distorter 200 and a feedback circuit 444 according to an embodiment of the invention.

The feedback circuit 444 includes a reference voltage source 460 two feedback circuit pre-distortion amplifiers 440 and 430, and feedback circuit output amplifier 450.

The reference voltage source generates a reference voltage Vref. The reference voltage Vref is provided to an envelope detector 410 and to the feedback circuit pre-distortion amplifiers 440 and 430. The output of these feedback circuit pre-distortion amplifiers 440 and 430 is fed to the feedback circuit output amplifier 450. The output signal of the feedback circuit output amplifier 450 is provided to a feedback offset circuit 420. The feedback offset circuit 420 also receives the output of the feedback circuit envelope detector 410. The feedback offset circuit 420 provides an offset signal to the feedback circuit pre-amplifier 430. The feedback circuit pre-amplifier 420 as illustrated as not receiving a feedback.

Vref may be selected such that a gain expansion function matches the gain compression of one of the I or Q pre-distortion amplifiers. The reference gain feedback control Loop of FIG. 9 is required to set the gain, and predistortion function shape. The gain and shape of the predistortion function are controlled by two parameters: Vref which is set by the adjustable resistive voltage divider and the adjustable gain of feedback circuit pre-amplifier 430. The gain of the feedback circuit pre-amplifier 430 is controlled by switching the source degeneration feedback poly-silicon resistors that divide Vdd to provide Vref.

In integrated RF systems the interconnection of the RF front end and package plays important role in overall system performance. According to various embodiments of the invention wire bonds are used for simultaneous matching and DC feeding of the RF front end that includes the RF amplifier 140 and a receiver 190. This scheme provides an advantage of low insertion loss and low cost implementation of the RF interfacing functions. This scheme is suitable for implementation on different wire-bond packages such as QFN, MLF, BGA and other popular wire-bond chip carriers.

FIG. 10 illustrates a prior art differential RF interface, which is commonly used in integrated RF transceivers.

First and third wire-bonds 561 and 563 connect differential RF interface of the package (substrate) 570 and die 580. The second wire-bond 562 is required for providing a DC bias to RF front end circuits. On-chip shunt inductors 530 and 540 are provided for simultaneous matching and biasing of the RF front end. These on-chip shunt inductors 530 and 540 have limited Q (quality factor) and high parasitic capacitance. Low Q and parasitic capacitance degrade available Tx RF Power, Tx efficiency and Rx Noise Figure. These on-chip shunt inductors 530 and 540 have a spiral shape and are printed on the die 580.

The following figure illustrates an RF interface eliminates the on-chip shunt inductors reducing the RF power losses associated with them.

FIG. 12 illustrates a differential RF Wire-bond Interface 640, a balun 610 and an antenna 660, according to an embodiment of the invention.

The balun 610 has a first and second balanced input ports 610(1) and 610(2) and a single unbalanced output port 610(3). The balun 610 include four quarter-wavelength conducting elements (hereinafter conductors) 612, 616, 614 and 618 that are proximate to each other. Conductors 614 and 618 are connected to each other. While a first end of conductor 618 is connected to conductor 614 the other end of conductor 618 forms the unbalanced output port 610(3). Two ends of conductors 616 and 612 form first and second balanced input ports 610(1) and 610(2). The four conductors 612, 614, 616 and 618 are connected in parallel to each other. Two ends of conductors 616 and 612 are connected via capacitors 611 and 613 to the ground.

Multiple wire-bonds 621-615 are connected between the balun 610 and the first and second differential output ports of the RF amplifier 140 and at least one wire-bond serve as potential shunt inductor. Conveniently, the first and fifth wire bonds 621 and 625 serve as potential shunt inductors.

FIG. 12 also illustrates five interfacing ports 641-645 that are printed on die 580. The first interface port 641 is coupled to the third interface port 643 and is coupled via a first wire-bond 621 to the first balanced input port 610(1) of the balun 610. The second interface port 642 is coupled to a first differential output port of the RF amplifier 140. The third interface port 643 is coupled via a third wire-bond 623 to a direct current (DC) source (VDD). The fourth interface port 644 is coupled to the second differential output port of the RF amplifier 140. The fifth interface port 645 is coupled to the third interface port 643 and is coupled via a fifth wire-bond 625 to the second balanced input port of the balun 610(2).

FIG. 12 also illustrates a receiver 190 that includes first and second differential inputs. The second interface port 642 is further coupled to the first differential input of the receiver 190. The fourth interface port 645 is further coupled to the second differential input of the receiver 190.

The first and fifth wire-bonds 621 and 615 serve as differential shunt inductors and provide DC power (from VDD—via third interface port 643) and bias to the first and second (“+” and “−”) terminals of PA and LNA. The direction of the magnetic coupling between a wire-bond pair that includes the first and second wire-bonds 621 and 622 and between another wire-bond pair that includes the fourth and fifth wire-bonds 624 and 625 facilitates differential mode of operation. The coupling direction is such that it reduces the differential current in the wire-bonds 621 and 625.

The third interface port 643 can be ESD protected while the other interface ports 641, 642, 644 and 645 may be without ESD protection and therefore can be made as low capacitance RF pads increasing the circuit frequency bandwidth.

The relative position and length of the wire-bonds 621-625 control self and mutual wire-bond inductance and allows tuning of the front end matching to the external antenna 660, filter or balun 610.

The described differential interface provides DC bias feed to the active front end circuits and allows use of the low capacitance RF pads facilitating wide bandwidth RF interface. The interface also offers low insertion loss as compared with use of alternative low-Q on-chip differential inductor. Also removal of the on chip inductor reduces the active die area.

FIG. 13 illustrates method 1900 for transmitting signals, according to an embodiment of the invention.

Method 1900 may include various stages such as a sequence of stages 1910, 1920, 1930, 1940, 1950, 1960, 1970 and 1980.

Stage 1910 includes receiving, by an analog base-band pre-distorter, in-phase (I) baseband signals and Quadrature (Q) baseband signals.

Stage 1920 includes amplifying the I baseband signals and the Q baseband signals by a gain function to provide amplified I baseband signals and amplified Q baseband signals; wherein the gain function is responsive to a sum of (a) a square of amplitudes of the I baseband signals and, (b) a square of amplitudes of the B baseband signals.

Stage 1930 includes converting, by a frequency converter, the amplified I and Q baseband signals to radio frequency (RF) signals.

Stage 1940 includes amplifying, by an RF amplifier, the RF signals to provide amplified RF signals.

Stage 1950 includes outputting differential RF signals from a first and a second differential output ports of the RF amplifier, wherein the differential RF signals represent the amplified RF signals.

Stage 1960 includes supplying the differential RF signals to an interface that is coupled via multiple wire-bonds coupled to two balanced input ports of a balun; wherein at least one wire-bond serve as potential shunt inductor.

Stage 1970 includes outputting RF signals from a single unbalanced output port of the balun to an antenna.

Stage 1980 includes transmitting RF signals from the antenna.

Method 1900 can be executed by system 10.

Stage 1960 may include providing RF differential signals from a first differential output port of the RF amplifier to a second interfacing port; and providing RF differential signals from a second differential output port of the RF amplifier to a fourth interfacing port. The second and fourth interfacing ports can be long to a set of five interfacing ports. The first interface port is coupled to a third interface port and is coupled via a wire-bond to the first balanced input port of the balun. The third interface port is coupled via a wire-bond to direct current (DC) source. The fifth interface port is coupled to the third interface port and is coupled via a wire-bond to the second balanced input port of the balun.

Method 1900 can also include stage 1990 of receiving signals. Stage 1990 may include providing RF signals from the balun to a receiver that comprises a first and second differential inputs. The second interface port is further coupled to the first differential input of the receiver. The fourth interface port is further coupled to the second differential input of the receiver.

The wire-bonds may couple between a balun that is connected to a substrate and between an integrated circuit that comprises the analog base-band pre-distorter, the frequency converter and the RF amplifier.

Stage 1930 may include converting the amplified I and Q baseband signals to ultra wide band (UWB) RF signals.

Method 1900 may also include stage 1912 of detecting an envelope of the I-channel baseband signals by an I-channel envelope detector and detecting an envelop of the Q-channel baseband signals by a Q-channel envelope detector.

Stage 1912 follows stage 1910 and precedes stage 1920.

Stage 1920 may include stages 1922 and 1924.

Stage 1922 includes amplifying, in response to the detected envelope of the I-channel baseband signals and the detected envelope of the Q-channel baseband signals, the I baseband signals by an I-channel pre-distortion amplifier.

Stage 1924 includes amplifying, in response to the detected envelope of the I-channel baseband signals and the detected envelope of the Q-channel baseband signals, the Q baseband signals by a Q-channel pre-distortion amplifier.

The I-channel pre-distortion amplifier may include two feedback resistors. Either one of stages 1922 and 1924 may include modulating a resistance of a first feedback resistor by the I-channel envelope detector and modulating a resistance of a second feedback resistor by the Q-channel envelope detector.

Method 1900 may also include stage 1914 of setting a small signal gain of the I-channel pre-distortion amplifier by an I-channel offset circuit; and setting a small signal gain of the Q-channel pre-distortion amplifier by a Q-channel offset circuit. Stage 1914 may be executed in parallel to stages such as stage 1910 and 1920. It may include setting the small signal gain of the I-channel pre-distortion amplifier and of the Q-channel pre-distortion amplifier by a reference gain feedback loop that is coupled to the I-channel pre-distortion amplifier and to the Q-channel pre-distortion amplifier. The reference gain feedback loop may include at least one reference pre-distortion amplifier that comprises poly-silicon feedback resistors.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system, comprising:
an analog base-band pre-distorter arranged to receive in-phase (I) baseband signals and Quadrature (Q) baseband signals, and to amplify the I baseband signals and the Q baseband signals by a gain function to provide amplified I baseband signals and amplified Q baseband signals; wherein the gain function is responsive to a sum of (a) a square of amplitudes of the I baseband signals and, (b) a square of amplitudes of the B baseband signals;
a frequency converter arranged to convert the amplified I and Q baseband signals to radio frequency (RF) signals;
an RF amplifier that is arranged to amplify the RF signals to provide amplified RF signals and to output differential RF signals that represent the amplified RF signals through first and second differential output ports of the RF amplifier;
a balun comprising a first and second balanced input ports and a single unbalanced output port;
multiple wire-bonds coupled between the balun and the first and second differential output ports of the RF amplifier; wherein at least one wire-bond serve as potential shunt inductor.

2. The system according to claim 1, comprising:
a first interface port that is coupled to a third interface port and is coupled via a wire-bond to the first balanced input port of the balun;
a second interface port that is coupled to the first differential output port of the RF amplifier;
a third interface port that is coupled via a wire-bond to direct current (DC) source;
a fourth interface port that is coupled to the second differential output port of the RF amplifier; and
a fifth interface port that is coupled to the third interface port and is coupled via a wire-bond to the second balanced input port of the balun.

3. The system according to claim 2, further comprising a receiver that comprises a first and second differential inputs; wherein the second interface port is further coupled to the first differential input of the receiver; and wherein the fourth interface port is further coupled to the second differential input of the receiver.

4. The system according to claim 1, wherein the wire-bonds couple between a balun that is connected to a substrate and between an integrated circuit that comprises the analog base-band pre-distorter, the frequency converter and the RF amplifier.

5. The system according to claim 1, wherein the frequency converter is arranged to convert the amplified I and Q baseband signals to ultra wide band (UWB) RF signals.

6. The system according to claim 1, wherein the analog base-band pre-distorter comprises:
an I-channel envelope detector,
a Q-channel envelope detector,
an I-channel pre-distortion amplifier that is coupled to the I-channel envelope detector and to the Q-channel envelope detector; and
a Q-channel pre-distortion amplifier that is coupled to the I-channel envelope detector and to the Q-channel envelope detector.

7. The system according to claim 6, wherein the I-channel pre-distortion amplifier comprises two feedback resistors; wherein a resistance of a first feedback resistor is modulated by the I-channel envelope detector and a resistance of a second feedback resistor is modulated by the Q-channel envelope detector.

8. The system according to claim 6, further comprising an I-channel offset circuit arranged to set a small signal gain of the I-channel pre-distortion amplifier and a Q-channel offset circuit arranged to set a small signal gain of the Q-channel pre-distortion amplifier.

9. The system according to claim 6, further comprising a reference gain feedback loop that is coupled to the I-channel pre-distortion amplifier and to the Q-channel pre-distortion amplifier.

10. The system according to claim 9, wherein the reference gain feedback loop comprises at least one reference pre-distortion amplifier that comprises poly-silicon feedback resistors.

11. A method for transmitting signals, the method comprises:
receiving, by a an analog base-band pre-distorter, in-phase (I) baseband signals and Quadrature (Q) baseband signals;
amplifying the I baseband signals and the Q baseband signals by a gain function to provide amplified I baseband signals and amplified Q baseband signals; wherein the gain function is responsive to a sum of (a) a square of amplitudes of the I baseband signals and, (b) a square of amplitudes of the B baseband signals;
converting, by a frequency converter, the amplified I and Q baseband signals to radio frequency (RF) signals;
amplifying, by an RF amplifier, the RF signals to provide amplified RF signals;
outputting differential RF signals from a first and a second differential output ports of the RF amplifier, wherein the differential RF signals represent the amplified RF signals;
supplying the differential RF signals to an interface that is coupled via multiple wire-bonds coupled to two balanced input ports of a balun; wherein at least one wire-bond serve as potential shunt inductor; and
outputting RF signals from a single unbalanced output port of the balun to an antenna.

12. The method according to claim 11, wherein the multiple wire-bonds are coupled to a first till fifth interfacing ports, wherein the method comprises:
providing RF differential signals from a first differential output port of the RF amplifier to a second interfacing port;
providing RF differential signals from a second differential output port of the RF amplifier to a fourth interfacing port;
wherein the first interface port is coupled to a third interface port and is coupled via a wire-bond to the first balanced input port of the balun;
wherein the third interface port is coupled via a wire-bond to direct current (DC) source; and
wherein the fifth interface port that is coupled to the third interface port and is coupled via a wire-bond to the second balanced input port of the balun.

13. The method according to claim 12, further comprising providing RF signals from the balun to a receiver that comprises a first and second differential inputs; wherein the second interface port is further coupled to the first differential input of the receiver; and wherein the fourth interface port is further coupled to the second differential input of the receiver.

14. The method according to claim 11, wherein the wire-bonds couple between a balun that is connected to a substrate and between an integrated circuit that comprises the analog base-band pre-distorter, the frequency converter and the RF amplifier.

15. The method according to claim 11, comprising converting the amplified I and Q baseband signals to ultra wide band (UWB) RF signals.

16. The method according to claim 11, comprising:
detecting an envelop of the I-channel baseband signals by an I-channel envelope detector;
detecting an envelop of the Q-channel baseband signals by a Q-channel envelope detector,
amplifying, in response to the detected envelope of the I-channel baseband signals and the detected envelope of the Q-channel baseband signals, the I baseband signals by an I-channel pre-distortion amplifier; and
amplifying, in response to the detected envelope of the I-channel baseband signals and the detected envelope of the Q-channel baseband signals, the Q baseband signals by a Q-channel pre-distortion amplifier.

17. The method according to claim 16, wherein the I-channel pre-distortion amplifier comprises two feedback resistors; wherein the method comprises modulating a resistance of a first feedback resistor by the I-channel envelope detector and modulating a resistance of a second feedback resistor by the Q-channel envelope detector.

18. The method according to claim 16, comprising setting a small signal gain of the I-channel pre-distortion amplifier by an I-channel offset circuit; and setting a small signal gain of the Q-channel pre-distortion amplifier by a Q-channel offset circuit.

19. The method according to claim 16, further comprising setting a small signal gain of the I-channel pre-distortion amplifier and of the Q-channel pre-distortion amplifier by a reference gain feedback loop that is coupled to the I-channel pre-distortion amplifier and to the Q-channel pre-distortion amplifier.

20. The method according to claim 19, wherein the reference gain feedback loop comprises at least one reference pre-distortion amplifier that comprises poly-silicon feedback resistors.
